(19) United States
(12) Patent Application Publication
(10) Pub. No.: US 2022/0161886 A1
(43) Pub. Date: May 26, 2022

(54) SELF-BALANCING SCOOTER

(71) Applicant: ZHEJIANG RAYMOND WAY ELECTRONIC TECHNOLOGY CO., LTD., Jinhua (CN)

(72) Inventor: JUNJIE WANG, Yongkang (CN)

(21) Appl. No.: 17/159,182

(22) Filed: Jan. 27, 2021

(30) Foreign Application Priority Data
Nov. 24, 2020 (CN) 202011329317.1

(51) Int. Cl. B62K 11/00; B62D 11/00; B62D 51/00

(52) U.S. Cl. CPC B62K 11/007; B62D 51/001; B62D 11/006

(57) ABSTRACT

The present invention discloses a self-balancing scooter, including a scooter body, two rotating assemblies, and two wheels, where two ends of each of the rotating assemblies are rotatably connected to the scooter body and the wheels respectively, the rotating assembly is provided with several clamping rods, and the scooter body is provided with several first clamping grooves for clamping and inserting the clamping rods to stack the wheels on the scooter body and several second clamping grooves for clamping and inserting the clamping rods to mount the wheels at ends of the scooter body. The self-balancing scooter according to the present invention can effectively prevent the stacked wheels from loosening, thereby facilitating transportation and carrying.

### TECHNICAL FIELD

The present invention relates to the technical field of self-balancing scooters, and in particular, to a self-balancing scooter.

### BACKGROUND

An electric self-balancing scooter is also called a thinking scooter. Its operating principle is mainly based on a basic principle called “dynamic stabilization”: Changes of the scooter body posture are detected by using a gyroscope and an acceleration sensor inside a scooter body, and a motor is accurately driven by using a servo control system to make corresponding adjustments, so as to keep the scooter body balanced.

However, the existing self-balancing scooter occupies a large space because of its protruding wheels, which does not facilitate carrying and transportation.

### SUMMARY

An object of the present invention is to provide a self-balancing scooter, to resolve the problem that the whole self-balancing scooter occupies a large space because of its protruding wheels, which does not facilitate carrying and transportation.

The present invention is implemented by using the following technical solution:

The present invention provides a self-balancing scooter, including a scooter body, two rotating assemblies, and two wheels, where two ends of each of the rotating assemblies are rotatably connected to the scooter body and the wheels respectively, the rotating assembly is provided with several clamping rods, and the scooter body is provided with several first clamping grooves for clamping and inserting the clamping rods to stack the wheels on the scooter body and several second clamping grooves for clamping and inserting the clamping rods to mount the wheels at ends of the scooter body.

Further, the rotating assembly includes a rotating plate, where the rotating plate includes a first supporting plate and two clamping rods convexly arranged at two ends of a middle portion of the first supporting plate respectively, one end of the first supporting plate is rotatably connected to the wheel, the other end thereof is rotatably connected to the scooter body, and limiting grooves for receiving the first supporting plate, two first clamping grooves communicated with the limiting grooves, and two second clamping grooves communicated with the limiting grooves are concavely formed at two ends of the scooter body respectively.

Further, the rotating assembly further includes two supporting members, where the rotating plate is positioned between the two supporting members, the wheel includes a roller and a bridge, the bridge includes a block, a first end and two second ends, the block has two first side wall surfaces arranged at intervals and two second side wall surfaces arranged at intervals, two ends of the first side wall surfaces are connected to the two second side wall surfaces respectively, the first end is convexly arranged on one first side wall surface, the roller is connected to the other first side wall surface, the two second ends are convexly arranged on the two second side wall surfaces respectively, the distance between the first end and the ground is greater than that between the second end and the ground, the first supporting plate is rotatably connected to the first end, one end of the supporting member is rotatably connected to the scooter body, and the other end thereof is rotatably connected to the second end.

Further, two first receiving grooves are further concavely formed at two ends of the scooter body respectively, the supporting member is L-shaped and includes a second supporting plate and a third supporting plate vertically connected to the second supporting plate, the second supporting plate is located in the first receiving groove and rotatably connected to the scooter body, and the third supporting plate is rotatably connected to the second end.

Further, the wheel further includes a protective cover, the roller includes a fixed disk connected to the block and a rotating roller arranged outside the fixed disk in a sleeved mode and rotatably connected to the fixed disk, one end of the protective cover is mounted on the fixed disk and defines an receiving space with the fixed disk, the other end thereof can abut against the scooter body, a first through-hole and two second through-holes pass through the protective cover and are all communicated with the receiving space, the block, the third supporting plate and the second end are all located in the receiving space, one end of the first end is located in the receiving space, the other end thereof is connected to the first supporting plate after passing through the first through-hole, one end of the second supporting plate is located outside the receiving space, and the other end thereof is connected to the third supporting plate after passing through the second through-hole.

Further, the scooter body includes a scooter seat, two guide plates, and two rotating shafts; the self-balancing scooter further includes two pull buckles rotatably connected to the scooter seat; second receiving grooves, two first receiving grooves, two opposite first avoidance spaces communicated with the second receiving grooves and two opposite second avoidance spaces communicated with the second receiving grooves are concavely formed at two ends of the scooter seat, one end of the guide plate is slidably mounted in the second receiving groove, the other end thereof is connected to the pull buckle, and the guide plate is provided with a third receiving groove, two opposite first hook-shaped grooves, two opposite second hook-shaped grooves, and two opposite avoidance grooves; the third receiving groove and the second receiving groove define the limiting groove, the first avoidance space is communicated with the limiting groove through the first hook-shaped groove, the second avoidance space is communicated with the limiting groove through the second hook-shaped groove, the first hook-shaped groove and the first avoidance space define the first clamping groove, the second hook-shaped groove and the second avoidance space define the second clamping groove, a middle portion of the rotating shaft is rotatably connected to the first supporting plate, and two ends of the rotating shaft are connected to the scooter seat after passing through the two avoidance grooves respectively.

Further, the guide plate includes a fourth supporting plate connected to the pull buckle and two supporting side plates arranged on two sides of the fourth supporting plate in a length direction of the fourth supporting plate respectively, the fourth supporting plate and the two supporting side plates define the third receiving groove, and the supporting side plate is provided with the first hook-shaped groove, the second hook-shaped groove, and the avoidance groove located between the first hook-shaped groove and the second hook-shaped groove.

Further, a fourth receiving groove is concavely formed in a middle portion of the scooter seat, two ends of the fourth receiving groove are communicated with the two limiting grooves respectively, and the two pull buckles are located in the fourth receiving groove.

Further, the self-balancing scooter further includes an elastic member located in the fourth receiving groove, where two ends of the elastic member are fixed to the two pull buckles respectively, and the elastic member and the guide plate are located on two sides of the pull buckle respectively.

Further, the self-balancing scooter further includes two elastic members located in the fourth receiving groove, where one end of each of the elastic members is fixed to the scooter seat, the other end thereof is connected to the pull buckle, and the elastic member and the guide plate are located on both sides of the pull buckle respectively.

Compared with the prior art, the present invention has the following beneficial effects:

In the present invention, wheels can be stacked on a scooter body through rotating assemblies, and clamping rods on the rotating assemblies are clamped in first clamping grooves in the scooter body after stacking, thereby effectively preventing the stacked wheels from loosening, reducing the size of the self-balancing scooter and further facilitating transportation and carrying; in addition, the clamping rods can be clamped in second clamping grooves in the scooter body again, so that the two wheels can be mounted at two ends of the scooter body to ensure that the self-balancing scooter can run normally.

### BRIEF DESCRIPTION OF DRAWINGS

FIG. 1 is a schematic structural diagram of a self-balancing scooter according to an embodiment of the present invention;

FIG. 2 is a partial enlarged schematic view of a position A in FIG. 1;

FIG. 3 is a first exploded view of a self-balancing scooter according to an embodiment of the present invention;

FIG. 4 is a second exploded view of a self-balancing scooter according to an embodiment of the present invention;

FIG. 5 is a schematic structural diagram of a self-balancing scooter after a cover plate is removed according to an embodiment of the present invention;

FIG. 6 is a schematic structural diagram of a scooter seat, rotating shafts and guide plates after combination according to an embodiment of the present invention;

FIG. 7 is a partial enlarged schematic view of a position B in FIG. 6;

FIG. 8 is a schematic structural diagram of a rotating plate according to an embodiment of the present invention;

FIG. 9 is a schematic structural diagram of a self-balancing scooter after being folded according to an embodiment of the present invention;

FIG. 10 is a schematic structural diagram of a bridge according to an embodiment of the present invention;

FIG. 11 is a schematic structural diagram of a guide plate according to an embodiment of the present invention; and

FIG. 12 is a schematic structural diagram of a scooter seat and rotating shafts after being combined according to an embodiment of the present invention.

In the figures:

10. Scooter body; 11. First clamping groove; 12. Second clamping groove; 13. Limiting groove; 14. Scooter seat; 141. First receiving groove; 142. Second receiving groove; 143. First avoidance space; 144. Second avoidance space; 145. Fourth receiving groove; 15. Guide plate; 151. Third receiving groove; 152. First hook-shaped groove; 153. Second hook-shaped groove; 154. Avoidance groove; 155. Fourth supporting plate; 156. Supporting side plate; 16. Rotating shaft; 20. Rotating assembly; 21. Rotating plate; 211. Clamping rod; 212. First supporting plate; 22. Supporting member; 221. Second supporting plate; 222. Third supporting plate; 30. Wheel; 31. Roller; 311. Fixed disk; 312. Rotating roller; 32. Bridge; 321. Block; 3211. First side wall surface; 3212. Second side wall surface; 322. First end; 323. Second end; 33. Protective cover; 331. First through-hole; 332. Second through-hole; 34. Receiving space; 40. Pull buckle; 41. Rotating hole; 50. Elastic member; 60. Cover plate; 61. Third through-hole.

### DESCRIPTION OF EMBODIMENTS

The present invention will be further described below with reference to the accompanying drawings and specific embodiments. It should be noted that all embodiments described below or all the technical features can be arbitrarily combined to form new embodiments, provided that no conflict occurs.

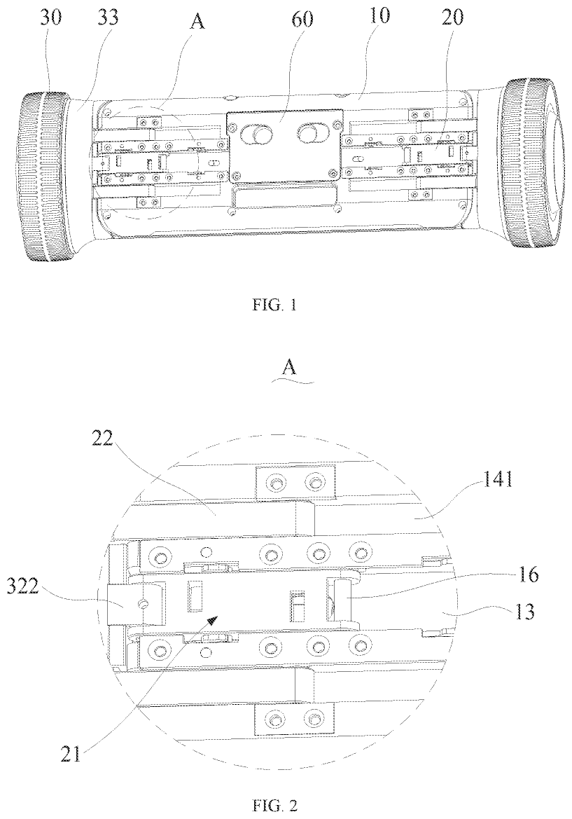

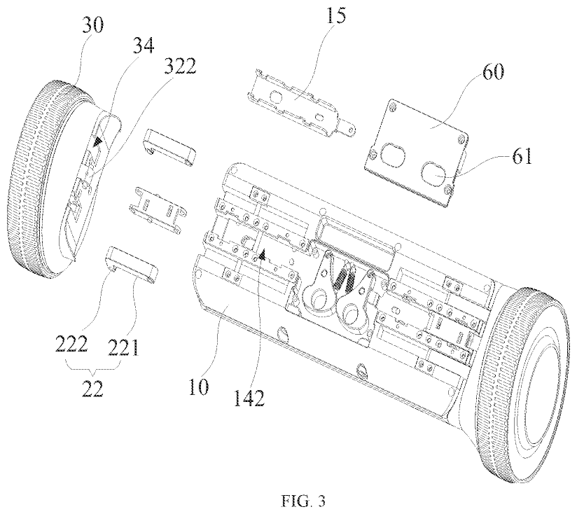

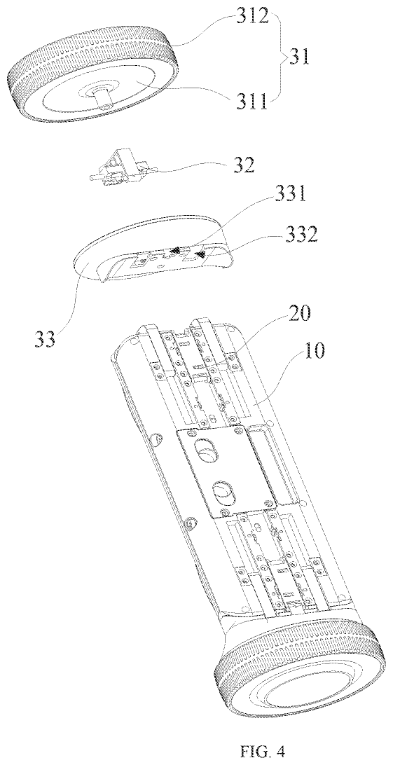

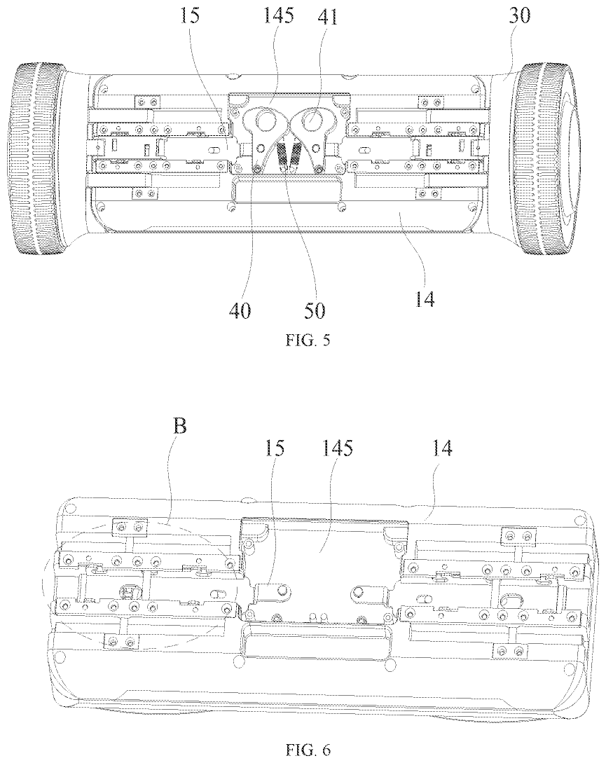

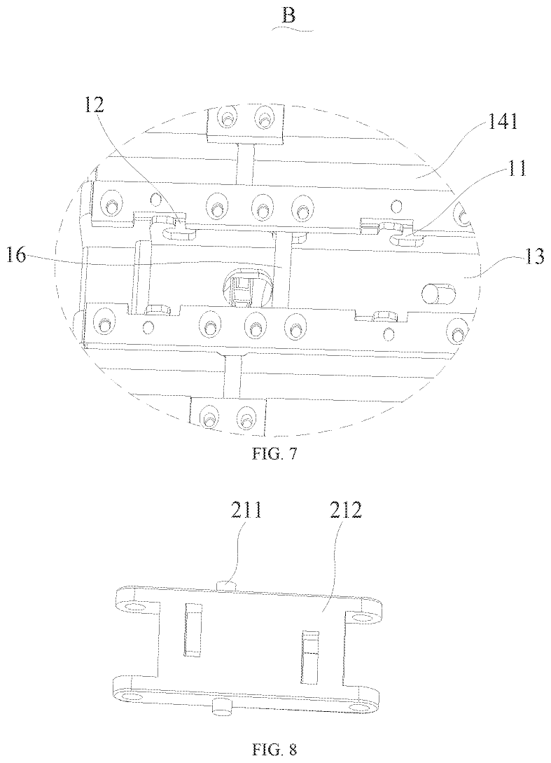

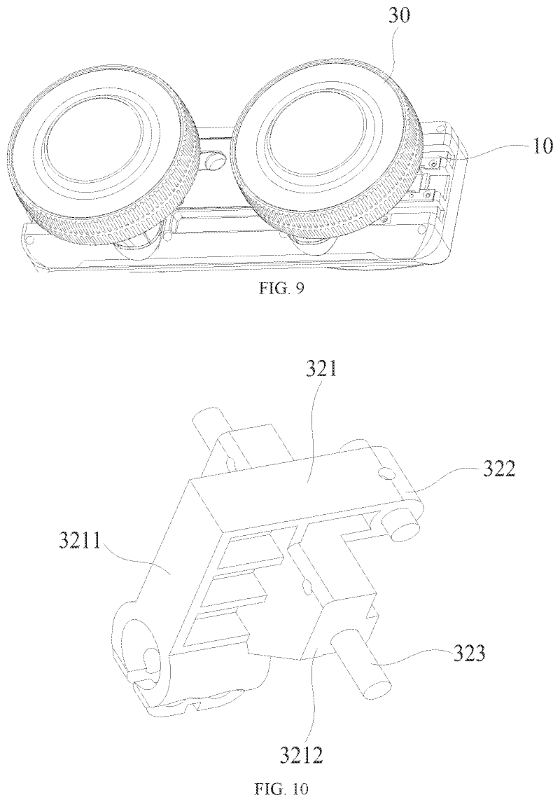

Referring to FIG. 1 to FIG. 9, the present invention discloses a self-balancing scooter, including a scooter body 10, two rotating assemblies 20, and two wheels 30, where two ends of each of the rotating assemblies 20 are rotatably connected to the scooter body 10 and the wheels 30 respectively, and when normal driving is required, the two wheels 30 can be mounted at both ends of the scooter body 10 through the two rotating assemblies 20 respectively.

The rotating assembly 20 is provided with several clamping rods 211, and the scooter body 10 is provided with several first clamping grooves 11 and several second clamping grooves 12. When each clamping rod 211 is clamped and inserted in the first clamping groove 11, the wheels 30 can be stacked on the scooter body 10, thereby effectively preventing the stacked wheels from loosening reducing the size of the self-balancing scooter and further facilitating transportation and carrying; and when each clamping rod 211 is clamped and inserted in the second clamping groove 12, the wheels 30 can be mounted at the end of the scooter body 10, to ensure that the self-balancing scooter can run normally.

Specifically, the rotating assembly 20 includes a rotating plate 21, the rotating plate 21 includes a first supporting plate 212 and two clamping rods 211 convexly arranged at two ends of a middle portion of the first supporting plate 212 respectively. The two clamping rods 211 are on the same axis, and the rotating plate 21 is of a cross-shaped structure. In this embodiment, the number of the clamping rods 211 is not limited.

One end of the first supporting plate 212 is rotatably connected to the wheel 30, and the other end thereof is rotatably connected to the scooter body 10. A limiting groove 13, two first clamping grooves 11 and two second clamping grooves 12 are concavely formed at two ends of the scooter body 10 respectively, the limiting groove 13 is formed in a length direction of the scooter body 10 to receive the first supporting plate 212; the two first clamping grooves 11 and the two second clamping grooves 12 are communicated with the limiting groove 13, the two first clamping grooves 11 are oppositely formed, the two clamping grooves 12 are oppositely formed, and in the length direction of the scooter body 10, the first clamping grooves 11 are located between several second clamping grooves 12.

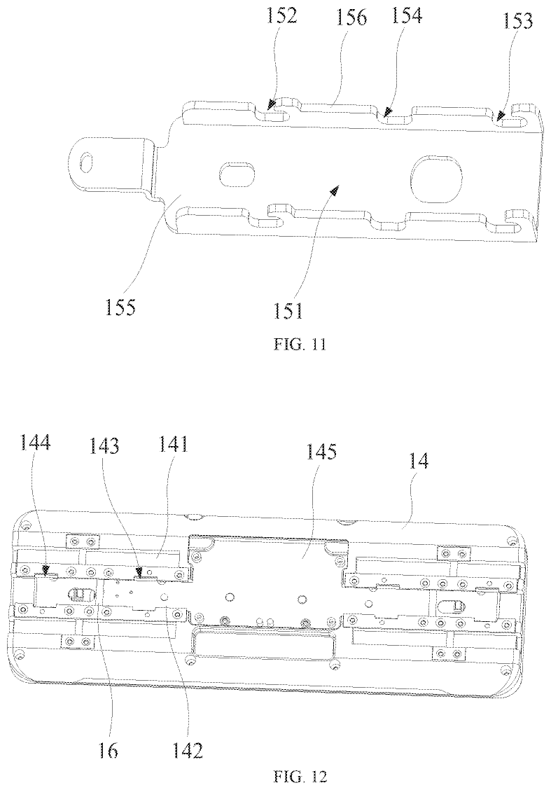

Still referring to FIG. 10 to FIG. 12, the rotating assembly 20 further includes two supporting members 22, the rotating plate 21 is located between the two supporting members 22, the wheel 30 includes a roller 31 and a bridge 32, and the bridge 32 is fixedly arranged on one side surface of the roller 31. The bridge 32 includes a block 321, two first ends 322 and two second ends 323, the block 321 has two first side wall surfaces 3211 arranged at intervals and two second side wall surfaces 3212 arranged at intervals, two ends of the first side wall surfaces 3211 are connected to the two second side wall surfaces 3212 respectively, the first end 322 is convexly arranged on one first side wall surface 3211, the roller 31 is connected to the other first side wall surface 3211, the two second ends 323 are convexly arranged on the two second side wall surfaces 3212 respectively, the distance between the first end 322 and the ground is greater than that between the second end 323 and the ground, the first supporting plate 212 is rotatably connected to the first end 322, one end of the supporting member 22 is rotatably connected to the scooter body 10, and the other end thereof is rotatably connected to the second end 323. The first end 322 and the second end 323 are neither on the same axis nor at the same height. As such, when the wheel 30 is mounted at the end of the scooter body 10 and pressed, the wheel 30 is not bent relative to the scooter body 10.

In a preferred embodiment, two first receiving grooves 141 are further concavely formed at two ends of the scooter body 10 respectively, and the supporting member 22 is L-shaped; the supporting member 22 includes a second supporting plate 221 and a third supporting plate 222 vertically connected to the second supporting plate 221, the second supporting plate 221 is located in the first receiving groove 141 and rotatably connected to the scooter body 10, and the third supporting plate 222 is rotatably connected to the second end 323. The distance between the rotation joint of the supporting member 22 and the scooter body 10 and the wheel 30 is less than the distance between the rotation joint of the first supporting plate 212 and the scooter body 10 and the wheel 30, so as to ensure that the wheel 30 is not bent relative to the scooter body 10 after the wheel 30 is mounted at the end of the scooter body 10 and pressed.

The wheel 30 further includes a protective cover 33, and the roller 31 includes a fixed disk 311 connected to the block 321 and a rotating roller 312 arranged outside the fixed disk 311 in a sleeved mode and rotatably connected to the fixed disk 311. The rotating roller 312 is annular, a hub motor is mounted in the fixed disk 311 and can drive the rotating roller 312 to rotate relative to the fixed disk 311, a control board electrically connected to the hub motor is arranged in the scooter body 10, one end of the protective cover 33 is mounted on the fixed disk 311 and defines an receiving space 34 with the fixed disk 311, and the other end thereof can abut against the scooter body 10. The protective cover 33 can further ensure that the wheel 30 is not bent relative to the scooter body 10 after the wheel 30 is mounted at the end of the scooter body 10 and pressed.

A first through-hole 331 and two second through-holes 332 pass through the protective cover 33. The first through-hole 331 and the two second through-holes 332 are all communicated with the receiving space 34. The block 321, the third supporting plate 222 and the second end 323 are all located in the receiving space 34, one end of the first end 322 is located in the receiving space 34, the other end thereof is connected to the first supporting plate 212 after passing through the first through-hole 331, one end of the second supporting plate 221 is located outside the receiving space 34, and the other end thereof is connected to the third supporting plate 222 after passing through the second through-hole 332. The inner diameter of the first through-hole 331 is much greater than the outer diameter of the first end 322, and the inner diameter of the second through-hole 332 is much greater than the outer diameter of the second supporting plate 221. As such, the first end 322 and the second supporting plate 221 do not interfere with the protective cover 33 when being bent.

The scooter body 10 includes a scooter seat 14, two guide plates 15, and two rotating shafts 16; the self-balancing scooter further includes two pull buckles 40 rotatably connected to the scooter seat 14; second receiving grooves 142, two first receiving grooves 141, two opposite first avoidance spaces 143 communicated with the second receiving grooves 142 and two opposite second avoidance spaces 144 communicated with the second receiving grooves 142 are concavely formed at two ends of the scooter seat 14, one end of the guide plate 15 is slidably mounted in the second receiving groove 142, the other end thereof is connected to the pull buckle 40, and the guide plate 15 is provided with a third receiving groove 151, two opposite first hook-shaped grooves 152, two opposite second hook-shaped grooves 153, and two opposite avoidance grooves 154; the third receiving groove 151 and the second receiving groove 142 define the limiting groove 13, the first avoidance space 143 is communicated with the limiting groove 13 through the first hook-shaped groove 152, the second avoidance space 144 is communicated with the limiting groove 13 through the second hook-shaped groove 153, the first hook-shaped groove 152 and the first avoidance space 143 define the first clamping groove 11, the second hook-shaped groove 153 and the second avoidance space 144 define the second clamping groove 12. As such, one end of the clamping rod 211 is connected to the first supporting plate 212, and the other end thereof sequentially passes through the first hook-shaped groove 152 and the first avoidance space 143; or one end of the clamping rod 211 is connected to the first supporting plate 212, and the other end thereof sequentially passes through the second hook-shaped groove 153 and the second avoidance space 144.

In this embodiment, a middle portion of the rotating shaft 16 is rotatably connected to the first supporting plate 212, two ends of the rotating shaft 16 are both connected to the scooter seat 14 after passing through the two avoidance grooves 154 respectively, and the rotating shaft 16 is fixed relative to the scooter seat 14.

The guide plate 15 includes a fourth supporting plate 155 connected to the pull buckle 40 and two supporting side plates 156 arranged on two sides of the fourth supporting plate 155 in a length direction of the fourth supporting plate 155 respectively, the length of the supporting side plate 156 is less than that of the fourth supporting plate 155, the fourth supporting plate 155 and the two supporting side plates 156 define the third receiving groove 151, and the supporting side plate 156 is provided with the first hook-shaped groove 152, the second hook-shaped groove 153, and the avoidance groove 154 located between the first hook-shaped groove 152 and the second hook-shaped groove 153.

In a preferred embodiment, a fourth receiving groove 145 is concavely formed in a middle portion of the scooter seat 14, two ends of the fourth receiving groove 145 are communicated with the two limiting grooves 13 respectively, and the two pull buckles 40 are located in the fourth receiving groove 145, so as to reduce the thickness of the scooter body 10 of the self-balancing scooter. In addition, when the pull buckle 40 abuts against an inner wall side of the fourth receiving groove 145, the first clamping groove 11 and the second clamping groove 12 will be in an open state.

In a preferred embodiment, the self-balancing scooter further includes several elastic members 50, the several elastic members 50 are located in the fourth receiving groove 145, and there may be one or two elastic members 50: when there is one elastic member 50, two ends of the member 50 are fixed to middle portions of the two pull buckles 40 respectively, and the elastic member 50 and the guide plate 15 are located on two sides of the pull buckle 40 respectively; when there are two elastic members 50, one end of each of the elastic members 50 is fixed to the scooter seat 14, the other end thereof is connected to the middle portion of the pull buckle 40, the elastic member 50 and the guide plate 15 are located on two sides of the pull buckle 40 respectively, and provided that the pull buckle 40 is not touched by the human hand, the elastic member 50 enables the clamping rod 211 to be in a clamped state in the first clamping groove 11 and the second clamping groove 12.

In a preferred embodiment, the pull buckle 40 is provided with rotating holes 41 for inserting the fingers; the self-balancing scooter further includes a cover plate 60, the cover plate 60 is fixed to the scooter seat 14 and arranged above the fourth receiving groove 145, the elastic member 50 and the pull buckle 40 are arranged below the cover plate 60, and the cover plate 60 is provided with two third through-holes 61 respectively corresponding to the two rotating holes 41, so as to insert the human hand.

The operating principle of the self-balancing scooter is as follows:

The self-balancing scooter is turned over, so that the bottom of the scooter body 10 is upward, and each pull buckle 40 is moved toward one side of the wheel 30 by hand until the pull buckle 40 is in contact with an inner side wall of the fourth receiving groove 145; at this time, the first clamping groove 11 and the second clamping groove 12 are in an open state, each wheel 30 can be overturned and folded onto the scooter body 10 through the rotating assembly 20; the pull buckle 40 remains stationary, the wheel 30 is pressed downward, the clamping rod 211 on the rotating assembly 20 is clamped into the first clamping groove 11, the pull buckle 40 is loosened, and the two wheels 30 are folded to one side of the scooter body 10. In this embodiment, the two pull buckles 40 can be moved separately.

When the self-balancing scooter needs to be used, one side of the bottom of the scooter body 10 is upward, the pull buckle 40 is moved by hand until the pull buckle 40 is in contact with the inner side wall of the fourth receiving groove 145, and at this time, the first clamping groove 11 and the second clamping groove 12 are in an open state; the folded wheels 30 are unfolded outward, so that the clamping rod 211 is separated from the first clamping groove 11, the pull buckle 40 is loosened, and the two wheels 30 are placed to two ends of the scooter body 10 respectively; the pull buckle 40 is moved by hand until it is in contact with the inner side wall of the fourth receiving groove 145, the rotating assembly 20 is pressed downward, so that the clamping rod 211 is clamped into the second clamping groove 12, the pull buckle 40 is loosened, and thus the two wheels 30 are fixed to two ends of the scooter body 10.

In conclusion, in the present invention, wheels 30 can be stacked on the scooter body 10 through rotating assemblies 20, and clamping rods 211 on the rotating assemblies 20 are clamped in first clamping grooves 11 in the scooter body 10 after stacking, thereby effectively preventing the stacked wheels from loosening, reducing the size of the self-balancing scooter and further facilitating transportation and carrying; in addition, the clamping rods 211 can be clamped in second clamping grooves 12 in the scooter body 10 again, so that the two wheels 30 can be mounted at two ends of the scooter body 10 to ensure that the self-balancing scooter can run normally.

The foregoing embodiments are only the preferred embodiments of the present invention, and cannot be used to limit the protection scope of the present invention. Any immaterial changes and replacements made by those skilled in the art on the basis of the present invention fall within the scope claimed by the present invention.

1. A self-balancing scooter, comprising a scooter body, two rotating assemblies, and two wheels, wherein two ends of each of the rotating assemblies are rotatably connected to the scooter body and the wheels respectively, the rotating assembly is provided with several clamping rods, and the scooter body is provided with several first clamping grooves for clamping and inserting the clamping rods to stack the wheels on the scooter body and several second clamping grooves for clamping and inserting the clamping rods to mount the wheels at ends of the scooter body.

2. The self-balancing scooter according to claim 1, wherein the rotating assembly comprises a rotating plate, the rotating plate comprises a first supporting plate and two clamping rods convexly arranged at two ends of a middle portion of the first supporting plate respectively, one end of the first supporting plate is rotatably connected to the wheel, and the other end thereof is rotatably connected to the scooter body; and limiting grooves for receiving the first supporting plate, two first clamping grooves communicated with the limiting grooves, and two second clamping grooves communicated with the limiting grooves are concavely formed at two ends of the scooter body respectively.

3. The self-balancing scooter according to claim 2, wherein the rotating assembly further comprises two supporting members, the rotating plate is positioned between the two supporting members, the wheel comprises a roller and a bridge, and the bridge comprises a block, a first end, and two second ends; the block has two first side wall surfaces arranged at intervals and two second side wall surfaces arranged at intervals, two ends of the first side wall surfaces are connected to the two second side wall surfaces respectively, the first end is convexly arranged on one first side wall surface, the roller is connected to the other first side wall surface, the two second ends are convexly arranged on the two second side wall surfaces respectively, the distance between the first end and the ground is greater than that between the second end and the ground, the first supporting plate is rotatably connected to the first end, one end of the supporting member is rotatably connected to the scooter body, and the other end thereof is rotatably connected to the second end.

4. The self-balancing scooter according to claim 3, wherein two first receiving grooves are further concavely formed at two ends of the scooter body respectively, the supporting member is L-shaped and comprises a second supporting plate and a third supporting plate vertically connected to the second supporting plate, the second supporting plate is located in the first receiving groove and rotatably connected to the scooter body, and the third supporting plate is rotatably connected to the second end.

5. The self-balancing scooter according to claim 4, wherein the wheel further comprises a protective cover, the roller comprises a fixed disk connected to the block and a rotating roller arranged outside the fixed disk in a sleeved mode and rotatably connected to the fixed disk, one end of the protective cover is mounted on the fixed disk and defines an receiving space with the fixed disk, the other end thereof can abut against the scooter body, a first through-hole and two second through-holes pass through the protective cover and are all communicated with the receiving space, the block, the third supporting plate and the second end are all located in the receiving space, one end of the first end is located in the receiving space, the other end thereof is connected to the first supporting plate after passing through the first through-hole, one end of the second supporting plate is located outside the receiving space, and the other end thereof is connected to the third supporting plate after passing through the second through-hole.

6. The self-balancing scooter according to claim 4, wherein the scooter body comprises a scooter seat, two guide plates, and two rotating shafts; the self-balancing scooter further comprises two pull buckles rotatably connected to the scooter seat; second receiving grooves, two first receiving grooves, two opposite first avoidance spaces communicated with the second receiving grooves and two opposite second avoidance spaces communicated with the second receiving grooves are concavely formed at two ends of the scooter seat, one end of the guide plate is slidably mounted in the second receiving groove, the other end thereof is connected to the pull buckle, and the guide plate is provided with a third receiving groove, two opposite first hook-shaped grooves, two opposite second hook-shaped grooves, and two opposite avoidance grooves; the third receiving groove and the second receiving groove define the limiting groove, the first avoidance space is communicated with the limiting groove through the first hook-shaped groove, the second avoidance space is communicated with the limiting groove through the second hook-shaped groove, the first hook-shaped groove and the first avoidance space define the first clamping groove, the second hook-shaped groove and the second avoidance space define the second clamping groove, a middle portion of the rotating shaft is rotatably connected to the first supporting plate, and two ends of the rotating shaft are connected to the scooter seat after passing through the two avoidance grooves respectively.

7. The self-balancing scooter according to claim 6, wherein the guide plate comprises a fourth supporting plate connected to the pull buckle and two supporting side plates arranged on two sides of the fourth supporting plate in a length direction of the fourth supporting plate respectively, the fourth supporting plate and the two supporting side plates define the third receiving groove, and the supporting side plate is provided with the first hook-shaped groove, the second hook-shaped groove, and the avoidance groove located between the first hook-shaped groove and the second hook-shaped groove.

8. The self-balancing scooter according to claim 6, wherein a fourth receiving groove is concavely formed in a middle portion of the scooter seat, two ends of the fourth receiving groove are communicated with the two limiting grooves respectively, and the two pull buckles are located in the fourth receiving groove.

9. The self-balancing scooter according to claim 8, further comprising an elastic member located in the fourth receiving groove, wherein two ends of the elastic member are fixed to the two pull buckles respectively, and the elastic member and the guide plate are located on two sides of the pull buckle respectively.

10. The self-balancing scooter according to claim 8, further comprising two elastic members located in the fourth receiving groove, wherein one end of each of the elastic members is fixed to the scooter seat, the other end thereof is connected to the pull buckle, and the elastic member and the guide plate are located on both sides of the pull buckle respectively.
